(19) United States
(12) Patent Application Publication
(10) Pub. No.: US 2010/0285294 A1
(43) Pub. Date: Nov. 11, 2010

(54) SANDWICH PANEL END EFFECTORS

(75) Inventors: Stephen Crane, Camano Island, WA (US); Mark Livesay, El Cajon, CA (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: SUNREZ CORPORATION, El Cajon, CA (US)

(21) Appl. No.: 12/670,634

(22) PCT Filed: Jul. 23, 2008
(86) PCT No.: PCT/US08/70921

§ 371 Date: Jun. 3, 2010

Related U.S. Application Data
(60) Provisional application No. 60/951,257, filed on Jul. 23, 2007.

(51) Int. Cl. B32B 7/08; B23P 11/00

(52) U.S. Cl. 428/223; 29/428

(57) ABSTRACT

Described herein are methods for production of sandwich panel end effectors and uses thereof, which may be used in various applications, such as aerospace, transportation, automobiles, aircraft, shipping, and construction. In one embodiment, the subject matter discloses an effective method for creating sandwich panel end effectors which are resistant to deformation or delamination and provide a point for affixing external loads.

### FIELD OF THE SUBJECT MATTER

The present subject matter relates to devices and methods used for forming sandwich panel end effectors.

### BACKGROUND OF THE SUBJECT MATTER

All publications herein are incorporated by reference to the same extent as if each individual publication or patent application was specifically and individually indicated to be incorporated by reference. The following description includes information that may be useful in understanding the present subject matter. It is not an admission that any of the information provided herein is prior art or relevant to the presently claimed subject matter, or that any publication specifically or implicitly referenced is prior art.

Sandwich panels are a class of composite materials that are fabricated by attaching two thin, yet stiff skins to a lightweight thick core. The skins may be made of an isotropic material like metal, or a sheet of plastic, or they can be made of orthotropic material like wood or fiber-reinforced polymer (“FRP”) composite. More recently, recycled paper has also been used over a closed-cell recycled kraft honeycomb core, creating a lightweight, strong and fully repulpable composite board. Open and closed cell structured foam, balsa wood and syntactic foam, and composite honeycomb are commonly used as core materials. Most commonly a foamed plastic, either thermoplastic or thermoset, is used for the core. Some common thermoplastics used include: linear polyvinylchloride (PVC), polystyrene (PS), polyethylene terephthalate (PET), styrenic poly acrylic nitrile (SPAN) and also polyethylene (PE), polypropylene (PP), polyamide (PA, nylon), polyetherimide (PEI), and polyimide (PI). Thermoset foams include cross linked variants of the aforementioned, as well as polyesters and polyurethanes, as well as phenolic, epoxy, and bismaleimide (BMI) foams.

Sandwich panels have been around for nearly one hundred years in one form or another, however, they did not gain popularity until World War II. During the war, the quest for light weight structures became important to maximize performance in aircraft. The Germans began the use of sandwich constructions such as in the wings of such aircraft as the Messerschmitt ME-109.

After the war, the engineering principles for such constructions, which are based on a principle similar to an “I” beam, became more clearly defined. This principle is the resistance to bending when a force is applied to any object and depends on: 1) its support conditions; 2) its shape normal to the direction the force is applied; and 3) the material of which it is made. If one disregards the first and third components for a moment, shape has a predominant effect. If the subject was a solid cube, it would exhibit the same resistance to bending if the force was applied to any of the six sides. The stiffness factor inherent in the shape of an object is called its moment of inertia (I). In the case of a solid object, it is defined as its width (side perpendicular to the applied force) times its thickness (side in line or normal to the applied force) cubed divided by twelve. I=bd³/12. If our cube was exchanged with another solid twice as wide but half as tall, its inherent stiffness would not be halved but would only be one-fourth as much. Inversely, doubling the thickness and halving the width increases the stiffness by four times.

The third factor used to determine the stiffness of an object is derived from the material used to produce the object. The inherent material stiffness is called Young's modulus of elasticity or simply, modulus of elasticity (E). In the cube example, if the cube was made of aluminum, its modulus of elasticity would be around 10,000,000 psi (pounds per square inch). If it was made of steel it would be around 30,000,000 psi. So if the cubes were the same size, the steel cube would have approximately three times the resistance to bending as the aluminum cube.

Combining the two factors mathematically, the stiffness of an object is defined as the modulus times the moment of inertia (EI). When designing to a desired stiffness, EI is the most important factor in choosing a material for a structure. When weight is factored in, aluminum is approximately one-third the weight of steel, but has one-third the modulus of elasticity. Since the two are equal in stiffness to density (commonly simplified to weight), they are said to have the same stiffness to weight ratio. If one wanted to change the steel cube to aluminum and keep it the same thickness, but were free to change the width in relation to the load, one would need to make it three times as wide. However, the weights of the objects would be the same.

When one considers why aluminum is an attractive choice of material, it is important to remember that stiffness increases as the cube of the thickness. So, aluminum begins to look a lot better as a material, since one would realize the benefits of weight reduction of the component. To achieve the same stiffness assuming the width of the cube was held constant, one would need only to increase the thickness of the aluminum cube by 44.2%. Since aluminum's density is only one-third as much as steel, one would have reduced weight by over half. It is important to understand that this is only in one axis because if flipped on its side, the aluminum object is still less than one-half as stiff.

In order to design a suitable component, one must understand the load on the component in terms of direction of application and magnitude. Simple physics dictates that if the object is edge supported and the top surface of the object is being compressed, then the side opposite from the applied force is in tension. The center of the cube in between these two sides is called the neutral axis. So, stiffness can be expressed as the ability of the top to resist compression and the bottom to resist tension. It follows that stiffness, or moment of inertia, can be expressed as thickness, and the distance of that thickness above and below this neutral axis.

Based on the above, it is clear that one of the most important features of the cube become the faces above and below the neutral axis. If the distance can be maintained from the outer face to the neutral axis and the face thickness is only thick enough to do the job, the structure is optimized even further.

In a real world example, the farther apart the outer faces (plates) are from the neutral axis, the thinner the face material. These faces need to be tied together to act as a single unit, and the connection between the two is called the web. Since one face is moving in one direction and the other face is moving in the opposite direction, the web sees some force, which is called shear-force (i). The net effect of shear force is that a steel cube 12 inches on each side would weigh 490 pounds. Based on these concepts, to make an “I” beam of precisely the same stiffness, one should start with faces (plates) only 0.50 inches thick and add a web only 0.25 inches thick. The web should be 3.5 times taller than the cube, but the whole beam would weigh only 76 pounds or 16% as much.

These same concepts apply to sandwich panels, where the thickness of the face plates and how far they are apart determine the overall stiffness. This effect can be combined with the proportionally low shear stress of the web (core) by utilizing low density foams or honeycombs, which can result in significant weight reduction for a given thickness. The goal then becomes producing the thinnest skins possible with the maximum allowed panel thickness. Ratios of 6 to 1 (combined skin thickness to total thickness) are considered an effective baseline and ratios of 15 to 1 are even more common. It should be clear based on the background provided why sandwich panels are utilized in nearly all modes of transportation and construction.

While providing a strong panel suited for loads in one axis, the thin skins of conventional sandwich panels are not suited for local loads. The thin skins cannot take the point loading like plywood or other traditional sheet goods (e.g. metals). Either local buckling or detachment from the core or both will be the result. Impact becomes another problem. Impact in the same direction as the normal force is applied can be compensated through design. Side impact, either straight on or at an angle to the skins, produces a combination buckling and adhesion problem. Some uniform method of addressing the problem of keeping the skins in unison or minimizing the local stress over the entire edge needed to be found.

Unlike the “I” beam construction in the example, conventional sandwich panels do not have a solid web for attachment, but instead have relatively soft foam or honeycomb cores. In the use of skin-core panels in construction, the issue then becomes how one attaches the panels to a structure or frame, so that the panel can be used as a stand-alone component similar to plywood or an aluminum sheet. Adhesive bonding would seem the best solution for distributing the load, but the question is how can this be done to minimize the axial loads on individual faces, which may induce peeling.

Thermoplastic matrix composite skins cause more significant problems, because the matrix (resin) holding the reinforcements (fiberglass, boron, basalt, carbon, Kevlar™ etc.) together is not stable under the influence of heat or constant load. Unfortunately many of these resins and plastics, such as olefins (polypropylene and polyethylene), cannot be glued satisfactorily, nor can they handle the point loading of a fastener. If adhesion issues did not present enough challenges, a more significant problem with this type of composite is “creep” or deformation over time due to a constant load. One solution to this problem is to “end fix” non-thermoplastic components to the composite face, which allows the reinforcements to take the load. This solution is analogous to attaching cable ends to a pre-stressed concrete construction, but even more critical as the cement does not change properties under the influence of heat or constant load. The load applied to these reinforcements must be applied in moderation; excessive preloading can cause premature rupture.

The current methods employed in attaching sandwich panels together and/or crowning a sandwich panel end include: a) skin reattachment; b) inserted end effectors; and c) slot inserted fittings.

### Skin Reattachment

In skin reattachment, the core can be held back from the edge and the skins together are attached at the panel end—usually on the neutral axis or parallel to the sandwich panel end.

FIG. 1 shows the most common method of crowning a sandwich panel 100, wherein, the bottom skin 102 is formed against a mold, the core 104 is applied, and the top skin 108 is applied over the core 104 reattaching to the bottom skin 102. Thereafter the end effector 106 is attached. One problem with this type of end effector 106 is that it does not load the sandwich panel 100 on the neutral axis. This design may be suitable for a sandwich panel 100 with loads applied to the bottom skin 102 toward the top skin 108, but it is unsuitable for loads in the opposite direction.

FIG. 2 shows a less common form of skin reattachment for a sandwich panel 200, wherein the core 204 is tapered to the center, and the bottom skin 202 and top skin 208 are joined together at the tapered neutral axis, fitting the end effector 206 at the neutral axis. The difficulty in forming this edge stems from the fact that the only method of obtaining the first side skin shape is to form it against a tool specifically designed for a panel of this size and thickness, thus requiring specific tooling and molds for varying sized panels, different shaped panels, as well as panels with varying skin and core thickness. The cost inhibitions of this method further exacerbates the viability of skin reattachment.

Both approaches to skin reattachment expose difficulties with creep and delamination as the greatest forces exerted on a sandwich panel are seen at the edges. Because the reattachment area does not benefit from the effect of skin spacing provided by the core, the panel needs to be over engineered in these areas—and more commonly in its entirety—to overcome this effect. When thermoplastics are considered, both approaches represent an unacceptable edge treatment. In FIG. 1, no amount of edge clamping pressure would prevent the tapered side from relaxing from creep. Even with the centralized positioning shown in FIG. 2, the side opposite to the force would suffer from the effects of creep due to the indirect path the reinforcement fibers would need to follow.

### Inserted End Effector

In contrast to the custom molded sandwich panels described above, many panels are made from a flat stock and the ends are added in a post-processing step. The most common practice to tailor the panels for the specific application is to machine out the core, which often leads to damaging the skins and weakening the structure, and inserting a filled resin system (e.g. putty) or a solid block.

The attachment may be made by fastening through the skins 302, 308 and the end effector 306, as shown in FIG. 3. Aside from the obvious potential for over cutting or under cutting of the core 304, any impact to the edge has the undesirable potential of peeling the skins. The skins 302, 308 are as vulnerable (if not more vulnerable) as they would be without an end effector 306. Another potential problem is rotation of the inserted system under load. Any load that would lead to rotation of the inserted system would subject the two skins 302, 308 to peeling, which would prove catastrophic to the sandwich panel 300.

In an effort to reduce creep and peeling in inserted end effectors, a secondary level of clamping 406 is often utilized, as shown in FIG. 4. While this additional clamp 406 may protect the end of the skins 402, 408 from impact, it actually promotes the peeling of the skins 402, 408 from the core 404 by adding additional moment to the rotation on loading.

Another flaw common to all post-processed edge effectors is that the skins cannot be pre-tensioned in any way, which implies that even with the best edge clamping, the panels will feel the effects of creep and as a result, deform when loaded.

### Slot Inserted Fittings

Because of the high potential of damaging the skins when cutting an insert on pre-processed panels, a second insert method has been commonly implemented. This method is particularly common in non-structural panels such as those commonly seen on aircraft interiors. FIG. 5 shows an example of this type of fitting.

In slot inserted fittings 506, a slot is cut into the core 504 of the sandwich panel 500 and a leg of a “T” shaped fitting 506 is press-fitted into the slot and is commonly accompanied by an adhesive. Alternatively or supplementally, some ends have barbs or other details on the insert leg to promote better grip. This type of end effector evolved from the particle board furniture industry and is commonly seen on that type of furniture. However, one very obvious drawback to this type of end-fitting is that minimal axial load upon the fitting 506 could cause a shear failure in the core 504, which would lead to catastrophic failure of the sandwich panel 500. Another drawback to the slotted inserted fitting 506 is minimal contact with the skins 502, 508 of the sandwich panel 500. As the skin provides strength to the panel and is the secure element of the structure, adequate contact with the skin is interrelated to the strength of the joint and the overall strength of the sandwich panel.

Despite the widespread use of sandwich panels, panel edge treatments remain relatively primitive, particularly if one requires a structural edge to utilize the favorable strength properties of the sandwich panel. This statement is particularly true with the advent of thermoplastic composites where thermal instability and creep are major limiting factors. The types of edge effectors common today do an acceptable job of protecting the edge from crushing but have numerous drawbacks as detailed above.

Accordingly, there is a need for a method and design for joining and crowning sandwich panel ends capable of supporting the sandwich panel edges without point loading the skins or creating creep in the skins, and without inducing peel between the skin and core. Furthermore, there is a need for a sandwich panel end effector which prevents damage to the sandwich panel in edge impacts, eliminates panel edge stiffening which may lead to panel end crushing, and is versatile enough to allow for application of interchangeable end fittings for multiple panel applications. Finally, there is a need for a sandwich panel joint configuration which encompasses at least one of the attributes stated above and is repairable.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 (prior art) depicts a cross-sectional view of a prior art sandwich panel end effector attachment method.

FIG. 2 (prior art) depicts a cross-sectional view of a prior art sandwich panel end effector attachment method.

FIG. 3 (prior art) depicts a cross-sectional view of a prior art sandwich panel end effector attachment method.

FIG. 4 (prior art) depicts a cross-sectional view of a prior art sandwich panel end effector attachment method.

FIG. 5 (prior art) depicts a cross-sectional view of a prior art sandwich panel end effector attachment method.

FIG. 6 depicts a cross-sectional view of a sandwich panel end effector attached to a sandwich panel in accordance with present subject matter.

FIG. 7 depicts a cross-sectional view of a sandwich panel end effector attached to a sandwich panel and incorporating a compression element in accordance with present subject matter.

FIG. 8 depicts a cross-sectional view of a sandwich panel end effector without the sandwich panel attached.

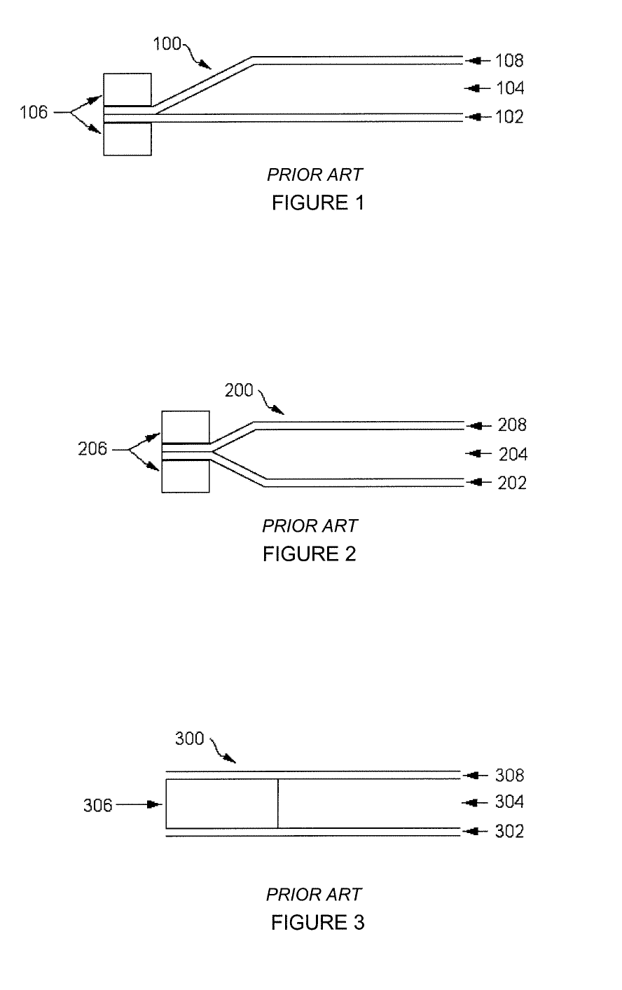

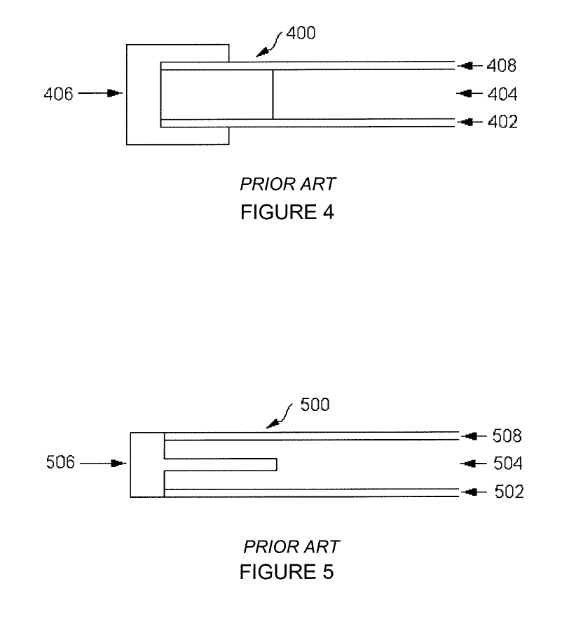

### DETAILED DESCRIPTION OF THE SUBJECT MATTER

All references cited herein are incorporated by reference in their entirety as though fully set forth. Unless defined otherwise, technical and scientific terms used herein have the same meaning as commonly understood by one of ordinary skill in the art to which this subject matter belongs. One skilled in the art will recognize many methods and materials similar or equivalent to those described herein, which could be used in the practice of the present subject matter. Indeed, the present subject matter is in no way limited to the methods and materials described.

The subject matter disclosed herein rectifies many, if not all, of the above-mentioned barriers facing current sandwich panel attachment technology. The subject matter utilizes a dual element end effector capable of application upon a wide range of existing sandwich panels. The subject matter effector is applicable in numerous industries including aircraft, tooling, automotive, shipping, transportation, construction, and aerospace.

The first element of the end effector consists of a base frame or insert 16. The insert 16 is constructed of a hardened material, generally a metal alloy or plastic, and is set against the core 14 of the sandwich panel 10, with the skin 12 surrounding the insert. Upon placement of the insert 16 into the sandwich panel 10, the surrounding skin 12 of the sandwich panel 10 is wrapped around the outer edges of the insert 16, producing the insert interface. The surrounding skin 12 butted up against the insert 16 provides a strong structural frame at the edge of the sandwich panel 10, which compliments the structural strength of the sandwich panel 10 and eliminates the weak link in a sandwich panel assembly: the ends. The encapsulated insert 16 not only stiffens the overall sandwich panel structure, but may be utilized as an anchoring point for pre-stressing the skins 12, which further increases the structural integrity of the sandwich panel end effector and sandwich panel assembly.

The second element of the effector consists of an exterior joint 18 which may be constructed of a hardened material, generally a metal alloy or plastic. One end of the exterior joint 18 is shaped to complement the insert 16 and mates up to the insert interface. The exterior joint 18 is constructed to surround the entire perimeter of the insert interface, lending support and protecting the sandwich panel ends. The opposing end of the exterior joint 18 may be constructed to accept fittings appropriate for use and/or manipulation of the sandwich panel 10. Additionally, the encapsulated insert 16 function as a mounting base for the exterior joint 18, allows for the simple replacement of damaged exterior joints 18, or adaptation of the exterior joint 18 for varying functions. For example, the exterior joint 18 may be constructed to accept a second sandwich panel, thus connecting sandwich panels to one another, or alternatively, may be constructed to accept a transport mechanism, such as a forklift.

The complementing surface of the exterior joint 18 acts to protect the surface of the sandwich panel skin at its weakest point. As discussed in detail above, the skin 12 of the sandwich panel is vulnerable to creep and separation at load bearing points, specifically the ends of the sandwich panel and joints. The subject exterior joint 18, in combination with the insert 16 interface, eliminates points of separation and creep in the sandwich panel 10 by encapsulating the insert reinforced skin 12, adding rigidity and stiffness to the ends of the sandwich panel 10.

The exterior joint 18 may be removably attached to the insert interface by fasteners 20 or other affixing devices, such as bolts, clamps or straps. In an alternative embodiment, the insert 16 may consist of a fastener 20 for removable attachment to the exterior joint 18.

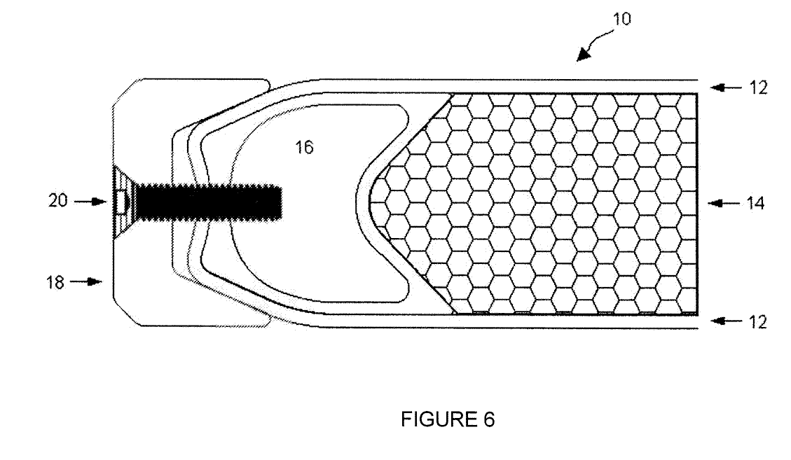

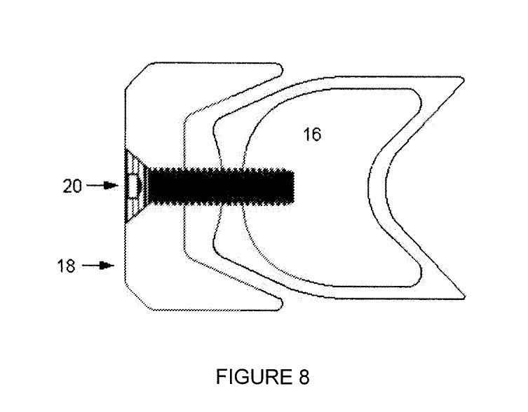

One preferred embodiment of the invention is primarily for panels requiring a lower level of skin end “fixity” or reinforcement. This would apply to panels with thermoset skins and panels requiring end attachment with lower loads. An example of an embodiment of the end effector attached to a sandwich panel can be seen in FIG. 6. An example of an embodiment of the end effector without the sandwich panel attached may be seen in FIG. 8.

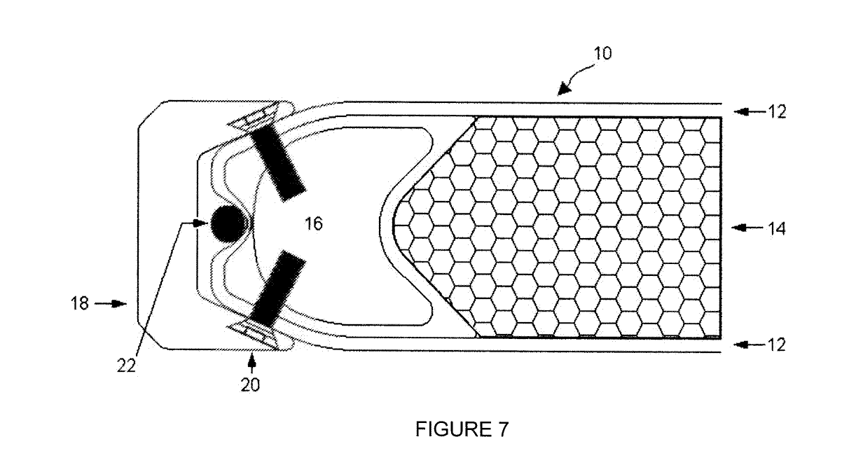

In an alternative embodiment, greater structural support characteristics of the panel may be accomplished by incorporating a compression band 22. The compression band 22 would surround the insert interface and may be mounted to an exterior frame for compressing the insert 16 while supporting the sandwich panel 10 structure. The compression band 22 may be tensioned to create preload upon the insert interface and sandwich panel 10 structure, adding rigidity and stability to the structure. The compression band 22 may comprise any suitable material for the application, including metals and metal alloys, stainless steel, cable or a line made of high strength polymers such as KEVLAR™ or SPECTRA™ or fiber reinforced polymers. The compression band 22 may alternatively be utilized to trap the skin 12 surrounding the insert 16, further securing the sandwich panel 10 structure. The exterior joint 18 would mate up against the insert interface and comprise of interchangeable elements to allow the panel end to be used in several different applications. The exterior joint 18 would provide protection for the skin ends, add structural stiffness to the internal rails, and could add clamping pressure as a primary or second level skin fixity. An example of an embodiment of the end effector with a compression band 22 compressing the insert 16 and skin 12 of a sandwich panel 10 may be seen in FIG. 7.

Proper application of the compression band while tensioning the skin will improve the properties of the skins and prevent degradation from creep. The “trapping” of the skin ends in this way will be particularly useful in the case of thermoplastic composites.

Effectors and related components disclosed herein may comprise any suitable material or combination of materials. The choice of material will depend entirely on the application and may depend, for instance, on whether the application requires more tensile strength, more flexibility, additional heat resistance, cost effectiveness or a combination thereof. Contemplated materials include metals, metal alloys, composite materials, plastics or a combination thereof. In addition, the components may be molded or formed prior to introduction to the skin system or may be formed in whole or in part during or after coupling with the skin system. Furthermore, the components of the subject matter effectors disclosed herein may be produced as two or three separate components, or may be formed into one consolidated component for application to the sandwich panel system.

In yet another embodiment, the sandwich panel structure may be enhanced by pre-tensioning the sandwich panel skins concurrently with and/or prior to modeling the skins to the insert. Alternatively or supplementally, the pre-tensioned skin may remain stressed while curing the modeled skin to the insert, further enhancing the structural composition of the sandwich panel and compressing the insert.

In another embodiment, the present subject matter is also directed at a kit intended for, but in no way limited to: (1) assembling sandwich panel ends; (2) retrofitting sandwich panel ends to existing sandwich panels; and/or (3) integrating sandwich panel ends in the manufacturing of sandwich panels. The kit is useful for practicing the inventive methods disclosed herein. The kit is an assemblage of materials or components, including at least one of the inventive elements. Thus, in primary embodiments the kit contains a component including an end effector, exterior joint, compression element, insert, fasteners, other relevant devices and combinations thereof.

The kits may include instructions for use. “Instructions for use” typically include a tangible expression describing the technique to be employed in using the elements of the kit to effect a desired outcome, such as to retrofit an insert to a sandwich panel end.

The materials or components assembled in the kit can be provided to the practitioner stored in any convenient and suitable way that preserves their operability, and/or utility. The components are typically contained in suitable packaging material(s). As employed herein, the phrase “packaging material” refers to one or more physical structures used to house the contents of the kit, such as inventive elements and the like. The packaging materials employed in the kit are those customarily utilized for like components. As used herein, the term “package” refers to a suitable solid matrix or material such as glass, plastic, paper, foil, and the like, capable of holding the individual kit elements. Thus, for example, a package can be a plastic wrap used to contain components of the inventive subject matter. The packaging material generally has an external label which indicates the contents and/or purpose of the kit and/or its elements.

The foregoing descriptions and examples of various embodiments of the subject matter known to the applicant at the time of filing this application have been presented and are intended for the purposes of illustration and description. The present descriptions and examples are not intended to be exhaustive nor limit the subject matter to the precise form disclosed and many modifications and variations are possible in light of the above teachings. The embodiments described serve to explain the principles of the subject matter and its practical application and to enable others skilled in the art to utilize the subject matter in various embodiments and with various modifications as are suited to the particular use contemplated. Therefore, it is intended that the subject matter disclosed herein not be limited to the particular embodiments disclosed.

While particular embodiments of the present subject matter have been shown and described, it will be obvious to those skilled in the art that, based upon the teachings herein, changes and modifications may be made without departing from this subject matter and its broader aspects and, therefore, the appended claims are to encompass within their scope all such changes and modifications as are within the true spirit and scope of this subject matter. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

What is claimed is:

1. A method of securing an end structure of a sandwich panel, comprising:
boring a core body of the sandwich panel at an end thereof, to expose sandwich panel skins;
placing an insert into a cavity formed by the core body of the sandwich panel;
modeling the sandwich panel skins to the insert to form an insert interface; and
affixing a removable exterior joint to the insert interface, wherein the exterior joint is complementary to the insert interface.

2. The method of claim 1, wherein the exterior joint is removably affixed to the insert interface by a fastener.

3. The method of claim 1, wherein the insert interface is surrounded by a compression band for securing the insert interface to the sandwich panel.

4. The method of claim 1, wherein the exterior joint is constructed to accept fittings for manipulation of the sandwich panel.

5. The method of claim 1, wherein the sandwich panel skins are pre-tensioned prior to modeling the skins to the body of the insert.

6. A method of securing the end structure of a sandwich panel, comprising:
placing an insert into a core body of the sandwich panel;
modeling a sandwich panel skin to the insert to form an insert interface; and
affixing a removable exterior joint to the insert interface, wherein the exterior joint is complementary to the surface of the insert interface.

7. The method of claim 6, wherein the exterior joint is removably affixed to the insert interface by a fastener.

8. The method of claim 6, wherein the insert interface is surrounded by a compression band for securing the insert interface to the sandwich panel.

9. The method of claim 6, wherein the exterior joint is constructed to accept fittings for manipulation of the sandwich panel.

10. The method of claim 6, wherein the sandwich panel skins are pre-tensioned prior to modeling the skins to the body of the insert.

11. A sandwich panel end structure comprising:
an insert configured to be attached to a core body of a sandwich panel at an end thereof, and to be encapsulated by the sandwich panel skin; and
an exterior joint configured to be removably affixed to the insert wherein the exterior joint is complementary to the insert.

12. The sandwich panel end structure of claim 10, further comprising a fastener for removably affixing the exterior joint to the insert.

13. The sandwich panel end structure of claim 10, further comprising a compression band for securing the insert to the sandwich panel.

14. The sandwich panel end structure of claim 10, further comprising an exterior joint constructed to accept fittings for manipulation of the sandwich panel.

15. A sandwich panel structure comprising:
a core body having a top and a bottom;
a superior skin affixed to the top of the core body;
an inferior skin affixed to the bottom of the core body and oriented opposite and parallel to the superior skin;
an insert affixed to the core body at an end thereof wherein the superior skin and inferior skin encapsulate the insert; and
an exterior joint removably attached to the insert, wherein the exterior joint is complementary to a surface of the insert.

16. The sandwich panel structure of claim 15, further comprising a fastener for removably affixing the exterior joint to the insert.

17. The sandwich panel structure of claim 15, further comprising a compression band for securing the insert to the core body.

18. The sandwich panel structure of claim 15, further comprising a compression band for securing the superior skin to the core body.

19. The sandwich panel structure of claim 15, further comprising a compression band for securing the inferior skin to the core body.

20. The sandwich panel structure of claim 15, further comprising an exterior joint constructed to accept fittings for manipulation of the sandwich panel.
